(19) United States
(12) Patent Application Publication
(10) Pub. No.: US 2010/0182300 A1
(43) Pub. Date: Jul. 22, 2010

(54) Driver circuit of display device

(75) Inventor: Fumihiko Kato, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kanagawa (JP)

(21) Appl. No.: 12/654,352

(22) Filed: Dec. 17, 2009

(30) Foreign Application Priority Data
Jan. 20, 2009 (JP) 2009-009670

(51) Int. Cl. G09G 5/00

(52) U.S. Cl. 345/211

(57) ABSTRACT

A driver circuit of a display device includes a gray-scale voltage circuit that generates a plurality of different reference voltages, a first selector circuit that selects one of the reference voltages as a first selected voltage and selects one of the reference voltages different from the first selected voltage as a second selected voltage, an amplifier that outputs an output voltage based on the first selected voltage, and an output voltage regulator circuit that regulates a potential of the output voltage by using a regulated voltage generated based on the first and second selected voltages. The output voltage regulator circuit regulates a potential of the output voltage from the amplifier. This allows reduction of the number of reference voltages generated in the gray-scale voltage circuit and the number of lines connecting the gray-scale voltage circuit and the first selector circuit, enabling reduction of the chip area of the driver circuit.

### BACKGROUND

1. Field of the Invention

The present invention relates to a driver circuit of a display device.

2. Description of Related Art

Recent progress towards higher performance and downsizing of a display device (liquid crystal panel) has been remarkable. Accordingly, higher performance is demanded also for a driver circuit of a liquid crystal panel.

A driver circuit of a liquid crystal panel includes the corresponding number of driver units to the number of data lines of the liquid crystal panel in order to apply a desired voltage to a pixel electrode included in each pixel of the liquid crystal panel. Further, the driver circuit includes a gray-scale voltage circuit that generates a plurality of different voltages in order that each driver unit can output a desired voltage.

Recently, progress towards a higher gray-scale level of a liquid crystal panel has been particularly remarkable. Accordingly, the number of lines that connect the gray-scale voltage circuit and the driver units is increasing. The increase in the number of lines leads to an increase in the chip area of the driver circuit (cf. Japanese Unexamined Patent Application Publication No. 2002-108312).

Japanese Unexamined Patent Application Publication No. 2001-34234 discloses a technique related to a driver circuit that includes an amplifier having two input terminals of the same characteristics. In this technique, voltages to be applied to the two input terminals are balanced by a decoder circuit, thereby reducing the number of lines connecting a gray-scale voltage circuit and the decoder circuit. This technique, however, can only reduce the number of lines to about half at the maximum. Therefore, the technique does not suppress an increase in the chip area of the driver circuit sufficiently enough to deal with the recent increase in the gray-scale level of the liquid crystal panel.

### SUMMARY

The present inventors have found an issue that it has been difficult to sufficiently reduce the chip area of a driver circuit against the trend of an increase in the number of lines connecting a gray-scale voltage circuit and a driver unit to deal with the recent increase in the gray-scale level of a display device.

A first exemplary aspect of an embodiment of the present invention is a driver circuit that includes (1) a gray-scale voltage circuit that generates a plurality of reference voltages different from one another, (2) a first selector circuit that selects any one of the reference voltages as a first selected voltage and selects any one of the reference voltages different from the first selected voltage as a second selected voltage, (3) an amplifier that outputs an output voltage based on the first selected voltage, and (4) an output voltage regulator circuit that regulates a potential of the output voltage by using a regulated voltage generated based on the first selected voltage and the second selected voltage.

A second exemplary aspect of an embodiment of the present invention is a driver circuit that includes (1) a gray-scale voltage circuit that generates a plurality of reference voltages having different voltage values from one another, (2) a first selector circuit that selects any one of the plurality of reference voltages as a first selected voltage, (3) an amplifier that outputs an output voltage based on the first selected voltage, and (4) an output voltage regulator circuit that regulates a potential of the output voltage by using a regulated voltage generated based on a first one and a second one of the reference voltages.

A third exemplary aspect of an embodiment of the present invention is a driver circuit of a display device that includes a gray-scale voltage circuit that generates a plurality of reference voltages having different voltage values from one another, and a plurality of unit driver circuits that are connected to the gray-scale voltage circuit through a plurality of lines, wherein each of the plurality of unit driver circuits includes (1) a first selector circuit that selects any one of the plurality of reference voltages as a first selected voltage, (2) an amplifier that outputs an output voltage based on the first selected voltage, and (3) an output voltage regulator circuit that regulates a potential of the output voltage by using a regulated voltage generated based on a first one and a second one of the reference voltages.

In the driver circuit according to the exemplary aspect of an embodiment of the present invention, the output voltage regulator circuit regulates a potential of the output voltage to be output from the amplifier. It is thus possible to reduce the number of reference voltages to be generated in the gray-scale voltage circuit. It is thereby possible to reduce the number of lines connecting the gray-scale voltage circuit and the first selector circuit, which consequently enables reduction of the chip area of the driver circuit. Accordingly, it is possible to sufficiently reduce the chip area of the driver circuit against the trend of an increase in the number of lines connecting the gray-scale voltage circuit and the driver unit to deal with the recent increase in the gray-scale level of a display device.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a schematic view to describe a configuration of a driver circuit according to a first exemplary embodiment;

FIG. 2 is a schematic view to describe a configuration of a gray-scale voltage circuit;

FIG. 3 is a schematic view to describe a change in transmittance of liquid crystals with respect to an applied voltage;

FIG. 4 is a schematic view to describe a configuration of a voltage divider;

FIG. 5 is a chart to describe a relationship between Vout and φ1;

FIG. 6 is a table to describe an example 1;

FIG. 7 is a schematic view to describe a configuration of a driver circuit according to a second exemplary embodiment;

FIG. 8 is a schematic view to describe a configuration of a transconductance circuit;

FIG. 9 is a table to describe an example 2;

FIG. 10 is an explanatory view to describe a relationship between a gray-scale voltage circuit and a plurality of unit driver circuits;

FIG. 11 is a schematic view to describe a configuration of a driver circuit 1C;

FIG. 12 is a schematic view to describe a configuration of a gray-scale voltage circuit 70;

FIG. 13 is a schematic view to describe a configuration of a driver circuit 1D; and

FIG. 14 is a schematic view to describe a configuration of a gray-scale voltage circuit 71.

### DETAILED DESCRIPTION OF THE EXEMPLARY EMBODIMENTS

Exemplary embodiments of the present invention are described hereinafter with reference to the drawings. The drawings are given in simplified form by way of illustration only, and thus are not to be considered as limiting the present invention. The same elements are denoted by the same reference symbols, and the redundant explanation is omitted.

### First Exemplary Embodiment

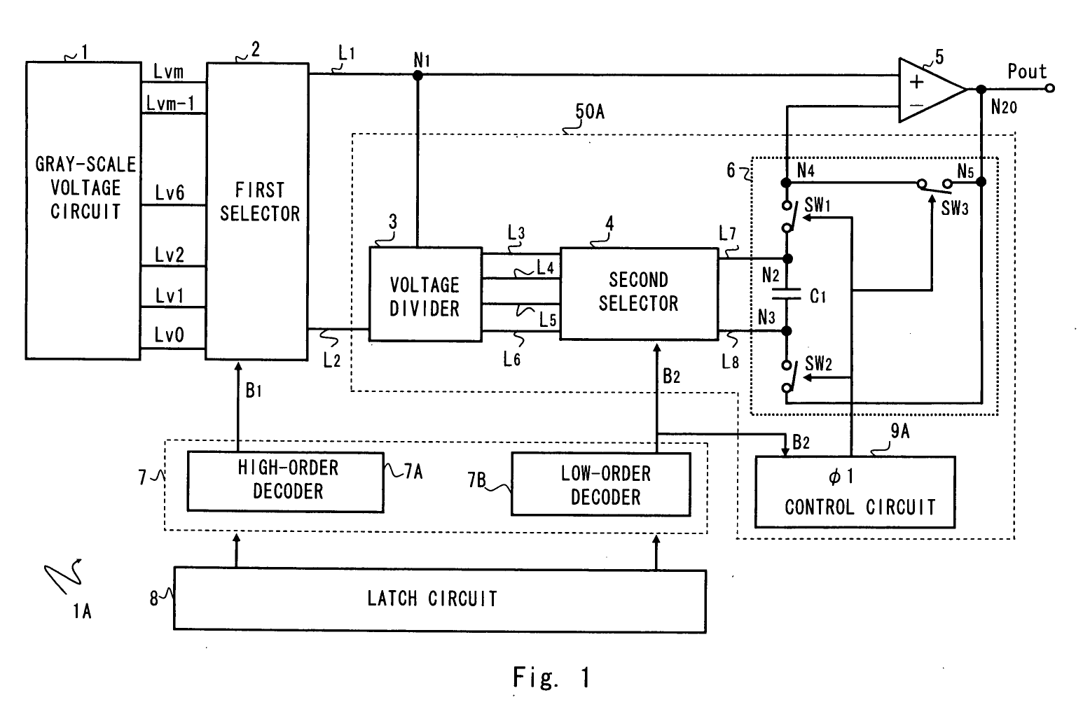

FIG. 1 shows a schematic configuration of a driver circuit 1A according to a first exemplary embodiment. Referring to FIG. 1, the driver circuit 1A includes a gray-scale voltage circuit 1, a first selector 2 (first selector circuit), an amplifier 5, an output voltage regulator circuit 50A, a decoder circuit 7, and a latch circuit 8.

### (Gray-Scale Voltage Circuit 1)

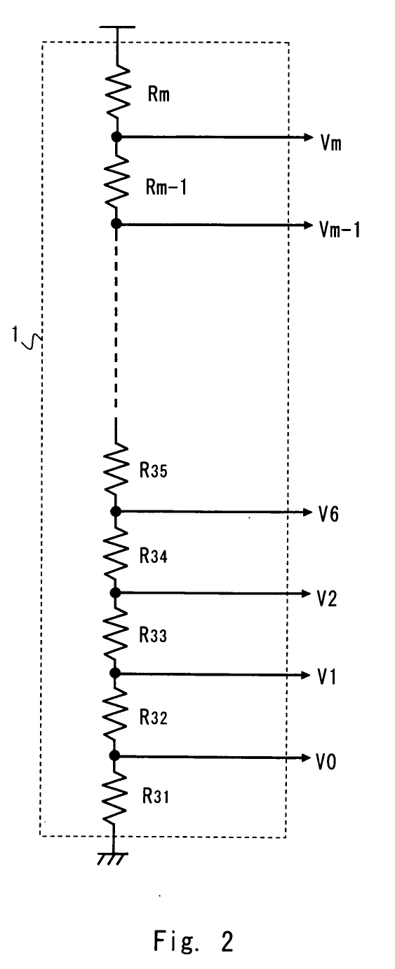

The gray-scale voltage circuit 1 is connected to the first selector 2 through lines Lv0 to Lvm. FIG. 2 shows an example of a specific configuration of the gray-scale voltage circuit 1. The gray-scale voltage circuit 1 includes a plurality of resistors R₃₁ to Rₘ (m is an arbitrary natural number). A plurality of different voltages (reference voltages) are output from nodes between adjacent resistors. For example, a reference voltage V0 is output from a node between the resistors R₃₁ and R₃₂. A reference voltage V1 is output from a node between the resistors R₃₂ and R₃₃. A reference voltage V2 is output from a node between the resistors R₃₃ and R₃₄. A reference voltage V6 is output from a node between the resistors R₃₄ and R₃₅. A reference voltage Vm is output from a node between the resistors Rₘ and Rₘ₋₁. The reference voltages (V0 to Vm) generated by the gray-scale voltage circuit 1 are thus input to the first selector 2 through the respective lines (Lv0 to Lvm).

The reference voltage V1 that is output from the gray-scale voltage circuit 1 is a voltage which is one level higher than the reference voltage V0 that is output from the gray-scale voltage circuit 1. Likewise, the reference voltage V6 is a voltage which is one level higher than the reference voltage V2. The reference voltage Vm is a voltage which is higher than the reference voltage V0 at m-number of levels.

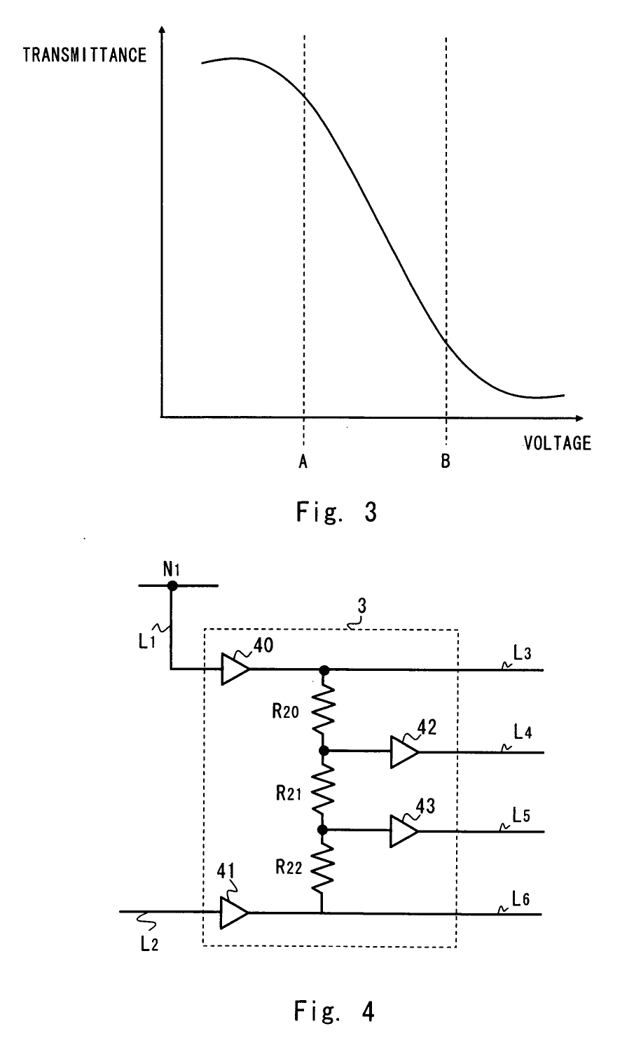

A potential difference between V1 and V2 and a potential difference between V0 and V1 are not necessarily equal. Likewise, a potential difference between V6 and V2 and a potential difference between V1 and V2 are not necessarily equal. This is described in detail with reference to FIG. 3.

Referring to FIG. 3, regarding liquid crystals held in a liquid crystal panel, there are a region of A-B (linear characteristic region) in which a change in transmittance with respect to an applied voltage is constant and a region outside A-B (non-linear characteristic region) in which it is not constant. It is thus necessary to design the driver circuit 1A for the liquid crystal panel in consideration of such characteristics of liquid crystals. Therefore, a potential difference between reference voltages output from the gray-scale voltage circuit 1 which are one level different from each other is generally not designed to be uniform in the range of an output voltage of the gray-scale voltage circuit 1.

The driver circuit 1A according to the exemplary embodiment includes an output voltage regulator circuit 50A, which is described later. It is thereby possible to reduce the number of reference voltages to be generated in the linear characteristic region by the gray-scale voltage circuit 1. Consequently, it is possible to not only reduce the size of the gray-scale voltage circuit 1 but also reduce the number of lines connecting the gray-scale voltage circuit 1 and the first selector 2. This will become clear from the explanation about the output voltage regulator circuit 50A, which is described later.

### (First Selector 2)

Referring back to FIG. 1, the first selector 2 is connected to the non-inverting input terminal of the amplifier 5 through a line L₁. Further, the first selector 2 is connected to the voltage divider 3 through a line L₂. The first selector 2 selects a reference voltage from the plurality of different reference voltages output from the gray-scale voltage circuit 1 based on a voltage signal B₁ corresponding to a high-order bit B1 supplied from a high-order decoder 7A included in the decoder circuit 7. The first selector 2 then outputs a selected reference voltage (first selected voltage) through the line L₁. Further, the first selector 2 outputs a selected reference voltage (second selected voltage) through the line L₂. The second selected voltage is a different reference voltage from the first selected voltage. In this example, the second selected voltage is a reference voltage which is one level lower than the first selected voltage. The first selector 2 selects, as the first selected voltage, any one voltage of the plurality of different reference voltages output from the gray-scale voltage circuit 1. Further, the first selector 2 selects, as the second selected voltage, any one voltage, which is different from the first selected voltage, of the plurality of different reference voltages output from the gray-scale voltage circuit 1. The first selector 2 then outputs the first selected voltage and the second selected voltage selected thereby. It is assumed in this example that the reference voltage selected as the first selected voltage and the reference voltage selected as the second selected voltage are different from each other at one level. It is thereby possible to simplify a configuration of the output voltage regulator circuit 50A, which is described later.

### (Amplifier 5)

The amplifier 5 outputs the first selected voltage which is output from the first selector 2 through its output end as an output voltage. The output end of the amplifier 5 is connected to an output port Pout.

In this exemplary embodiment, when the first selected voltage is in the above-described non-linear characteristic region, a voltage Vout which is output from the driver circuit 1A is equal to the output voltage described above. However, when the first selected voltage is in the above-described linear characteristic region, the voltage Vout which is output from the driver circuit 1A is a voltage in which a regulated voltage, which is described later, is added to the output voltage described above.

Note that, when the voltage is near the boundary between the linear characteristic region and the non-linear characteristic region, the regulated voltage is not necessarily added to the voltage Vout.

The voltage Vout which is output from the driver circuit 1A is applied to a pixel electrode of a liquid crystal cell through a data line included in the liquid crystal panel.

The decoder circuit 7 generates a control signal based on digital data stored in the latch circuit 8. The decoder circuit 7 includes a high-order decoder 7A corresponding to the high-order bit of the digital data supplied from the latch circuit 8. The decoder circuit 7 also includes a low-order decoder 7B corresponding to the low-order bit of the digital data supplied from the latch circuit 8. The voltage signal B₁ corresponding to the high-order bit which is generated in the high-order decoder 7A is input to the first selector 2 from the high-order decoder 7A. A voltage signal B₂ corresponding to the low-order bit which is generated in the low-order decoder 7B is input to a second selector 4, which is described later, from the low-order decoder 7B.

### (Output Voltage Regulator Circuit 50B)

The driver circuit 1A according to the exemplary embodiment includes the output voltage regulator circuit 50A. The output voltage regulator circuit 50A includes the voltage divider 3, the second selector 4, a potential regulator 6, and a control circuit 9A.

### (Voltage Divider 3)

The voltage divider 3 is connected to the second selector 4 through lines L₃ to L₆. Further, the voltage divider 3 receives the first selected voltage from the first selector 2 through the line L₁ and also receives the second selected voltage from the first selector 2 through the line L₂.

FIG. 4 shows an example of a configuration of the voltage divider 3. Referring to FIG. 4, the voltage divider 3 includes a plurality of buffers 40 to 43 and a plurality of resistors (R₂₀, R₂₁ and R₂₂). The voltage divider 3 outputs the first selected voltage which is input through the line L₁, through the line L₃. Further, the voltage divider 3 outputs the second selected voltage which is input through the line L₂, through the line L₆. Furthermore, the voltage divider 3 outputs voltages (divided voltages) obtained by dividing the first selected voltage and the second selected voltage through lines L₄ and L₅.

In this example, the resistors R₂₀, R₂₁ and R₂₂ are set to R₂₀:R₂₁:R₂₂=1:1:2. Thus, a divided voltage of Vs2+3(Vs1−Vs2)/4 is set to the line L₄. Further, a divided voltage of Vs2+2(Vs1−Vs2)/4 is set to the line L₅.

When the operating state of the first selector 2 is in the on-state, the first selector 2 supplies the first selected voltage and the second selected voltage to the voltage divider 3 all the time. Further, when the operating state of the voltage divider 3 is in the on-state, the voltage divider 3 supplies the divided voltages or the like to the second selector 4, which is described later, all the time.

### (Second Selector 4)

The second selector 4 is connected to the voltage divider 3 through the lines L₃ to L₆. Further, the voltage signal B₂ corresponding to the low-order bit is input to the second selector 4 from the low-order decoder 7B described above. The second selector 4 is also connected to the potential regulator 6 through lines L₇ and L₈.

The second selector 4 selects two voltages from the voltages which are output from the voltage divider 3 based on the voltage signal B₂ output from the low-order decoder 7B. The second selector 4 then outputs a first one of the selected voltage to one end of a capacitor C₁ included in the output voltage regulator circuit 50A (the configuration of which is described later) through the line L₇. Further, the second selector 4 outputs a second one of the selected voltage to the other end of the capacitor C₁ included in the output voltage regulator circuit 50A (the configuration of which is also described later) through the line L₈. Because the voltage signal B₂ corresponds to the low-order bit of the digital data, the second selector 4 selects two out of a plurality of voltages output from the voltage divider 3 based on the digital data (specifically, the low-order bit of the digital data).

The second selector 4 according to the exemplary embodiment operates only when the first selected voltage is included in the above-described linear characteristic region. Thus, the second selector 4 does not operate when the first selected voltage is not included in the linear characteristic region and therefore does not set any voltage to the lines L₇ and L_{8.} In such a configuration where the second selector 4 operates only when the first selected voltage is included in the linear characteristic region, it is possible to deal with an increase in the gray-scale level of a liquid crystal display device with a simple structure (particularly, the simple structure of the voltage divider 3 described above) in spite of reducing the number of lines between the gray-scale voltage circuit 1 and the second selector 4.

### (Potential Regulator 6)

The potential regulator 6 is connected to the second selector 4 through the lines L₇ and L_{8.} The potential regulator 6 is also connected to the output end of the amplifier 5 and the output port Pout through a node N₂₀. The potential regulator 6 includes the capacitor C₁ that stores a differential voltage between two voltages output from the second selector 4 and a plurality of switches SW₁ to SW₃ that cause the capacitor C₁ to store the differential voltage or cause the differential voltage stored in the capacitor C₁ to be added to the output voltage which is output from the amplifier 5.

In this example, the switches SW₁ and SW₂ are P-Channel Metal-Oxide-Semiconductor (MOS) transistors. The switch SW₃ is an N-channel MOS transistor. A control pulse (φ1) from the control circuit 9A is applied to the gate (control terminal) of each switch. The control circuit 9A operates in synchronization with the voltage signal B₂ supplied from the decoder circuit 7.

One end of the capacitor C₁ (differential potential storage capacitor) is connected to the switch SW₁. The end of the capacitor C₁ is electrically connected to the output end of the amplifier 5 through the switches SW₁ and SW₃. The other end of the capacitor C₁ is connected to the switch SW₂. A first output terminal of the second selector 4 is connected to a node N₂ between the capacitor C₁ and the switch SW₁ through the line L₇. A second output terminal of the second selector 4 is connected to a node N₃ between the capacitor C, and the switch SW₂ through the line L₈.

When the switch SW₁ and the switch SW₂ are both in the off-state, a differential voltage between the two voltages which are selected and output by the second selector 4 is stored in the capacitor C₁. When the switch SW₁ and the switch SW₂ are both in the on-state and the switch SW₃ is in the off-state, a voltage (regulated voltage Vreg) stored in the capacitor C₁ is added to the output voltage of the amplifier 5. The regulated voltage is set based on a potential difference between the two voltages which are selected by the second selector 4 from a plurality of voltages output from the voltage divider 3 in accordance with the low-order bit. Because the voltage divider 3 outputs voltages based on the first selected voltage and the second selected voltage, the regulated voltage is generated based on the first selected voltage and the second selected voltage.

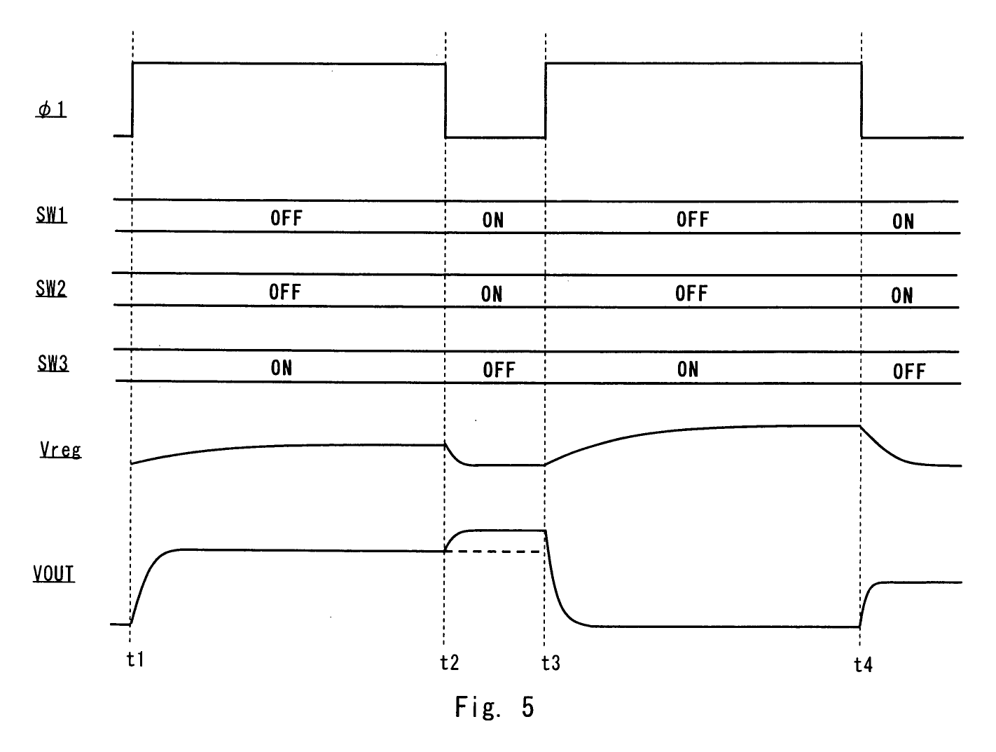

The relationship between the operation of the potential regulator 6 and the voltage output from the driver circuit 1A is described hereinafter with reference to FIG. 5. At time t1, the switch SW₁ and the switch SW₂ are in the off-state, and the switch SW₃ is in the on-state. At this time, a differential voltage (regulated voltage Vreg) between a voltage flowing through the line L₇ and a voltage flowing through the line L₈ is stored in the capacitor C₁. Further, the voltage Vout which is output from the driver circuit 1A is equal to the output voltage which is output from the output end of the amplifier 5 based on the first selected voltage. At time t2, the switch SW₁ and the switch SW₂ become the on-state, and the switch SW₃ becomes the off-state. At this time, the regulated voltage Vreg is added to the voltage Vout which is output from the driver circuit 1A.

The operation at time t3 corresponds to that at time t1, and the operation at time t4 corresponds to that at time t2. They are thus not redundantly described.

The time t2 may be set earlier (i.e. the time closer to the time t1).

### Example 1

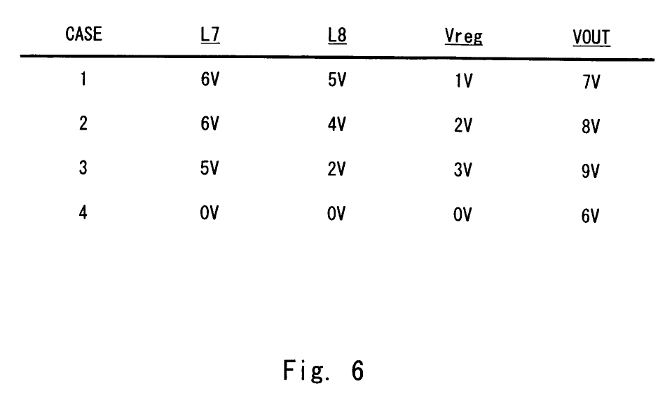

An example in the case where the first selector 2 selects the reference voltage V6 as the first selected voltage and selects the reference voltage V2 as the second selected voltage based on the high-order bit is described hereinbelow with reference to FIG. 6. It is assumed that the reference voltage V6 is a voltage of 6V and the reference voltage V2 is a voltage of 2V. At this time, V6 is set to the line L₁ as the first selected voltage, and V2 is set to the line L₂ as the second selected voltage. In this case, the voltage divider 3 sets 6V to the line L₃ and 2V to the line L₆. Further, the voltage divider 3 sets 5V to the line L₄ and 4V to the line L₅ based on V6 and V2.

The second selector 4 selects two voltages out of 6V, 5V, 4V and 2V based on the low-order bit, and then sets one to the line L₇ and the other one to the line L₈.

Referring to FIG. 6, in CASE1, the second selector 4 sets 6V to the line L₇ and 5V to the line L₈. Then, the regulated voltage Vreg of 1V is stored in the capacitor C₁. By the operation of the potential regulator 6 described above, the regulated voltage Vreg (1V) is added to the output voltage (6V) which is output from the amplifier 5. Then, the voltage Vout which is output from the driver circuit 1A is set to 7V.

In CASE2, the second selector 4 sets 6V to the line L₇ and 4V to the line L₈. Then, the regulated voltage Vreg of 2V is stored in the capacitor C₁. By the operation of the potential regulator 6 described above, the regulated voltage Vreg (2V) is added to the output voltage (6V) which is output from the amplifier 5. Then, the voltage Vout which is output from the driver circuit 1A is set to 8V.

In CASE3, the second selector 4 sets 5V to the line L₇ and 2V to the line L₃. Then, the regulated voltage Vreg of 3V is stored in the capacitor C₁. By the operation of the potential regulator 6 described above, the regulated voltage Vreg (3V) is added to the output voltage (6V) which is output from the amplifier 5. Then, the voltage Vout which is output from the driver circuit 1A is set to 9V.

In CASE4, the second selector 4 sets 0V to the line L₇ and 0V to the line L₈. Then, the regulated voltage Vreg of 0V is stored in the capacitor C₁. In this case, the voltage Vout which is output from the driver circuit 1A remains 6V. The voltage Vout can be set to 6V also by turning the switches SW₁ and SW₂ included in the potential regulator 6 to the off-state.

Because the output voltage regulator circuit 50A operates in this manner, it is possible to deal with an increase in the gray-scale level of the liquid crystal panel in spite of reducing the number of reference voltages generated in the gray-scale voltage circuit 1. Specifically, it is possible to deal with an increase in the gray-scale level of the liquid crystal panel in spite of reducing the number of lines connecting the gray-scale voltage circuit 1 and the first selector 2, thereby enabling suppression of an increase in the chip area of the driver circuit 1A.

Further, in this exemplary embodiment, the driver circuit 1A is configured so as to conform to the above-described linear characteristic region. It is thereby possible to simplify the configuration of the gray-scale voltage circuit 1 and the voltage divider 3, particularly.

### Second Exemplary Embodiment

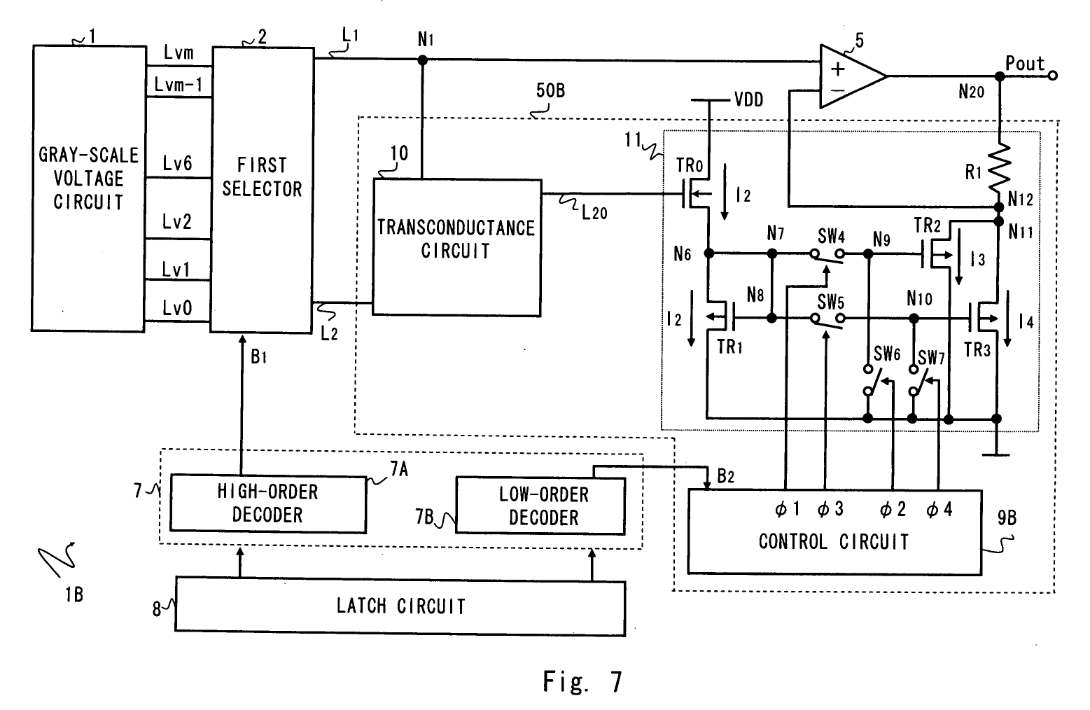

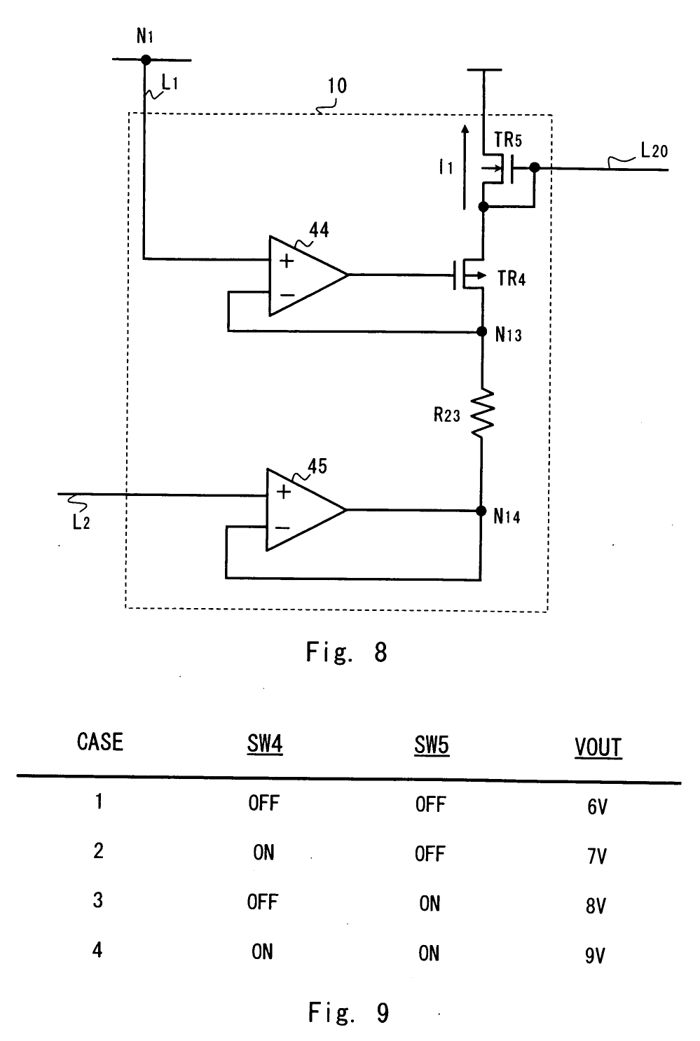

A second exemplary embodiment is described hereinafter with reference to FIGS. 7 and 8. A driver circuit 1B according to the exemplary embodiment includes an output voltage regulator circuit 50B. The voltage Vout which is output from the driver circuit 1B is generated by adding the regulated voltage to the output voltage which is output from the amplifier 5 when the first selected voltage is in the linear characteristic region. In this case also, the same advantage as described in the first exemplary embodiment can be obtained.

The output voltage regulator circuit 50B includes a transconductance circuit 10, a potential regulator 11 and a control circuit 9B.

### (Transconductance Circuit 10)

The transconductance circuit 10 is connected to the lines L₁ and L₂. The transconductance circuit 10 is also connected to the potential regulator 11 through a line L₂₀.

FIG. 8 shows a configuration of the transconductance circuit 10. Referring to FIG. 8, the transconductance circuit 10 includes an amplifier 44 corresponding to the line L₁ and an amplifier 45 corresponding to the line L₂. The transconductance circuit 10 also includes an N-channel MOS transistor TR₅, a P-channel MOS transistor TR₄, and a resistor R₂₃. The gate and the source of the transistor TR₅ are short-circuited. A node N₁₃ is connected between the transistor TR₄ and one end of the resistor R₂₃. A node N₁₄ is connected to the other end of the resistor R₂₃.

The non-inverting input terminal of the amplifier 44 is connected to the line L₁, and the inverting input terminal of the amplifier 44 is connected to the node N₁₃. The output end of the amplifier 44 is connected to the gate of the transistor TR₄. The non-inverting input terminal of the amplifier 45 is connected to the line L₂, and the inverting input terminal of the amplifier 45 is connected to the node N₁₄. The output end of the amplifier 45 is also connected to the node N₁₄.

The first selected voltage is input to the non-inverting input terminal of the amplifier 44 through the line L₁. The second selected voltage is input to the non-inverting input terminal of the amplifier 45 through the line L₂. Then, a voltage arising from a potential difference between the first selected voltage and the second selected voltage is generated in the resistor R₂₃ placed between the node N₁₃ and the node N₁₄. At this time, the transistor TR₄ is in the on-state. Thus, a current (first current) I1 arising from a potential difference between the first selected voltage and the second selected voltage flows into the transistor TR₅.

### (Potential Regulator 11)

The potential regulator 11 includes an N-channel MOS transistor TR₀, P-channel MOS transistors TR₁, TR₂ and TR₃, switches SW₄ to SW₇, and a resistor R₁. The switches SW₄ to SW₇ are in the on-state or the off-state based on a control signal from the control circuit 9B. The operating states of the switches SW₄ to SW₇ are set by the control circuit 9B. The control circuit 9B controls the switches SW₄ to SW₇ based on the voltage signal B₂ corresponding to the low-order bit which is supplied from the low-order decoder 7B. One end of the resistor R₁ is connected to a node N₂₀ between the amplifier 5 and the output port. Thus, one end of the resistor R₁ is connected to the output end of the amplifier 5.

The gate of the transistor TR₃ is connected to the gate of the above-described transistor TR₅ through the line L₂₀. The transistor TR₀ and the above-described transistor TR₅ are in a mirror configuration. Thus, a current (second current) I2 corresponding to the first current I1 flowing through the transistor TR₅ flows into the transistor TR₁ . The transconductance circuit 10 and the potential regulator 11 are connected by a current mirror circuit.

The source of the transistor TR₀ is connected to the source of the transistor TR₁. The gate and the source of the transistors TR₁ are short-circuited by a line connecting a node N₆ and a node N₈. A node N₇ between the node N₆ and the node N₈ is connected to one end of the switch SW₄. The other end of the switch SW₄ is connected to the gate of the transistor TR₂. When the switch SW₄ is in the on-state, the transistor TR₁ and the transistor TR₂ form a current mirror circuit (first current mirror circuit).

One end of the switch SW₅ is connected to the node N₈. The other end of the node N₅ is connected to the gate of the transistor TR₃. When the switch SW₅ is in the on-state, the transistor TR, and the transistor TR₃ form a current mirror circuit (second current mirror circuit).

The first current mirror circuit and the second current mirror circuit are both formed by using the transistor TR₁ as the input-side transistor. As the output-side transistor, on the other hand, the first current mirror circuit is formed by using the transistor TR₂, and the second current mirror circuit is formed by using the transistor TR₃ The transistor TR₂ and the transistor TR₃ have different transistor sizes. Accordingly, an output current which is output from the first current mirror circuit and an output current which is output from the second current mirror circuit with respect to the same input current are different from each other.

When the first current mirror circuit is in the on-state and the second current I2 flows into the transistor TR₁, a third current I₃ flows into the transistor TR₂. When the second current mirror circuit is in the on-state and the second current I2 flows into the transistor TR₁, a fourth current I₄ flows into the transistor TR₃. In this example, the transistor sizes of the transistors TR₁, TR₂, and TR₃ are set to TR₁:TR₂:TR₃=4:1:2. Thus, the fourth current I₄ has a larger current value than the third current I₃.

One end of the switch SW₆ is connected to a node between the transistor TR₂ and the switch SW₄. One end of the switch SW₇ is connected to a node between the transistor TR₃ and the switch SW₅.

When the switch SW₄ becomes the off-state, the switch SW₆ becomes the on-state. The transistor TR₂ can be thereby turned into the off-state with reliability. Likewise, when the switch SW₅ becomes the off-state, the switch SW₇ becomes the on-state. The transistor TR₃ can be thereby turned into the off-state with reliability.

The sources of the transistors TR₂ and TR₃ are connected at a node N₁₁. The node N₁₁ is connected to a node N₂₀ between the output end of the amplifier 5 and the output port Pout. A node N₁₂ between the node N₁₁ and the node N₂₀ is connected to the inverting input terminal of the amplifier 5.

If the switch SW₄ and the switch SW₆ are transistors of the same polarity, a control signal (φ1) supplied from the control circuit 9B to the switch SW₄ and a control signal (φ2) supplied from the control circuit 9B to the switch SW₆ have opposite phases. Likewise, if the switch SW₅ and the switch SW₇ are transistors of the same polarity, a control signal (φ3) supplied from the control circuit 9B to the switch SW₅ and a control signal (φ4) supplied from the control circuit 9B to the switch SW₇ have opposite phases.

### Example 2

An example in the case where the first selector 2 selects the reference voltage V6 as the first selected voltage and selects the reference voltage V2 as the second selected voltage based on the high-order bit is described hereinbelow with reference to FIG. 9. As in the first exemplary embodiment, it is assumed that the reference voltage V6 is a voltage of 6V and the reference voltage V2 is a voltage of 2V. Further, at this time, V6 is set to the line L₁ as the first selected voltage, and V2 is set to the line L₂ as the second selected voltage.

Referring to FIG. 9, in CASE1, the switch SW₄ and the switch SW₅ are both in the off-state. The first current mirror circuit and the second current mirror circuit are both in the off-state. Accordingly, the output voltage regulator circuit 50B does not operate, and the voltage Vout which is output from the driver circuit 1B is 6V that is equal to the first selected voltage.

In CASE2, the switch SW₄ is in the on-state, and the switch SW₅ is in the off-state. The first current mirror circuit is in the on-state, and the second current mirror circuit is in the off-state. At this time, a current (third current) corresponding to the second current flowing through the transistors TR₀ and TR₁ flows into the transistor TR₂. Further, a voltage (regulated voltage) of 1V corresponding to the value of the third current is generated at both ends of the resistor R₁. Then, the regulated voltage (1V) is added to the output voltage (6V) output from the amplifier 5, so that the voltage Vout which is output from the driver circuit 1B is set to 7V.

In CASE3, the switch SW₄ is in the off-state, and the switch SW₅ is in the on-state. The first current mirror circuit is in the off-state, and the second current mirror circuit is in the on-state. At this time, a current (fourth current) corresponding to the second current flowing through the transistors TR₀ and TR₁ flows into the transistor TR₃. Further, a voltage (regulated voltage) of 2V corresponding to the value of the third current is generated at both ends of the resistor R₁. Then, the regulated voltage (2V) is added to the output voltage (6V) output from the amplifier 5, so that the voltage Vout which is output from the driver circuit 1B is set to 8V.

In CASE4, the switch SW₄ is in the on-state, and the switch SW₅ is also in the on-state. The first current mirror circuit is in the on-state, and the second current mirror circuit is also in the on-state. At this time, currents (third current and fourth current) corresponding to the second current flowing through the transistors TR₀ and TR₁ flow into the transistors TR₂ and TR₃, respectively. Further, a voltage (regulated voltage) of 3V corresponding to a current that is the sum of the third current flowing through the transistor TR₂ and the fourth current flowing through the transistor TR₃ is generated at both ends of the resistor R₁. Then, the regulated voltage (3V) is added to the output voltage (6V) output from the amplifier 5, so that the voltage Vout which is output from the driver circuit 1B is set to 9V.

### Third Exemplary Embodiment

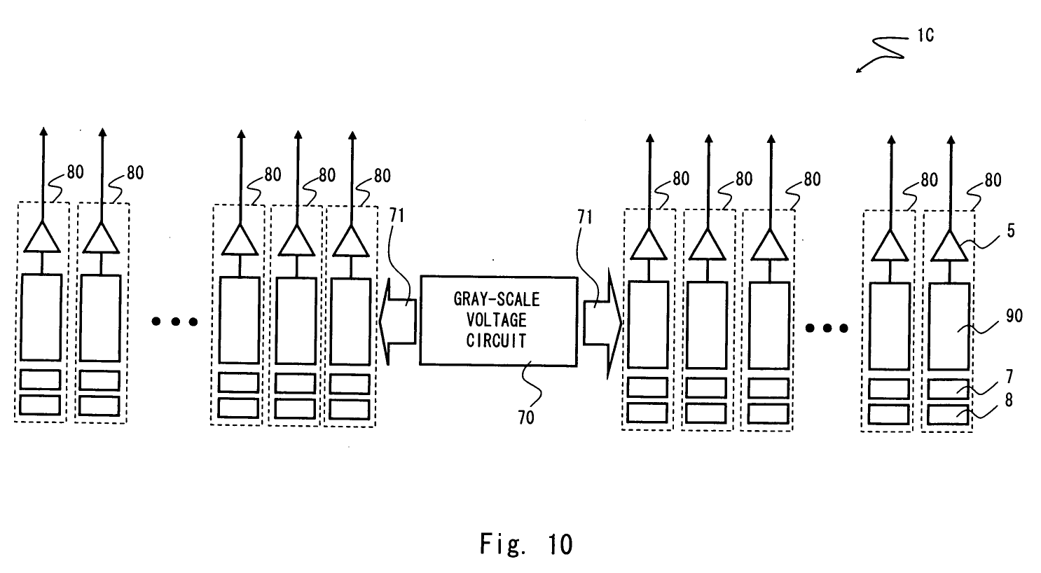

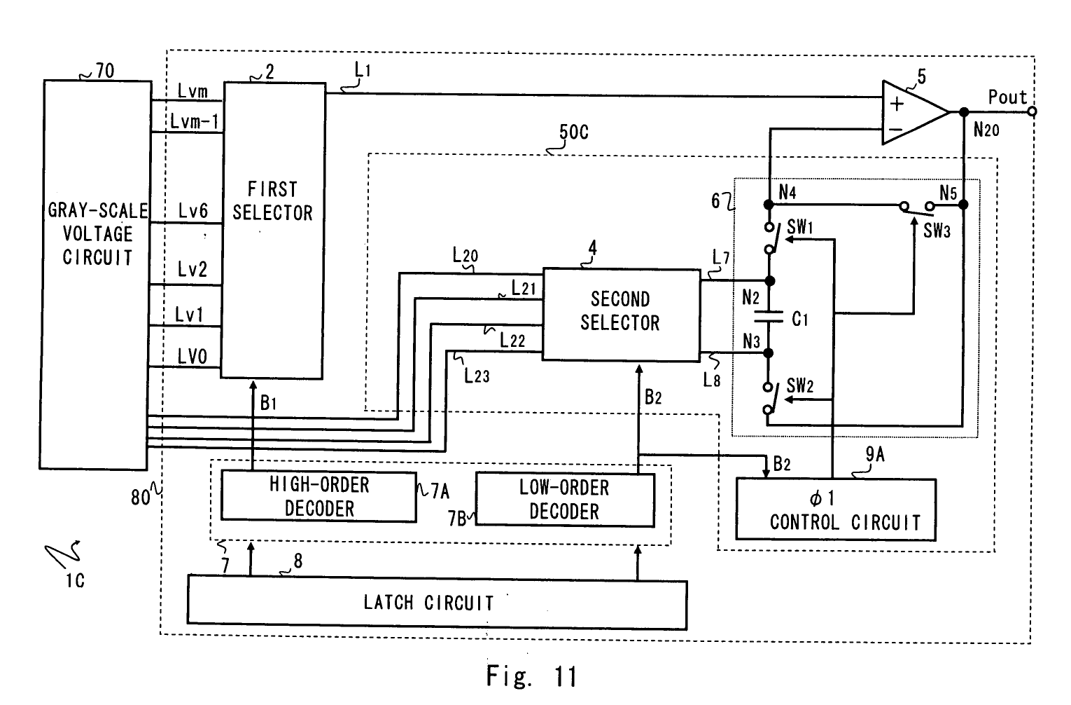

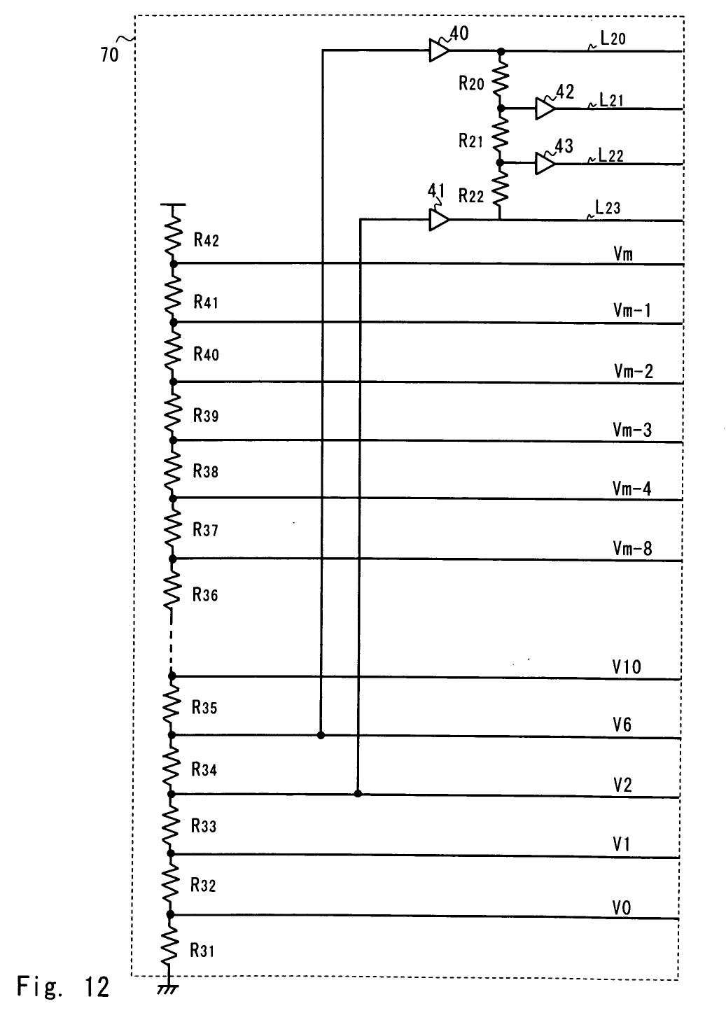

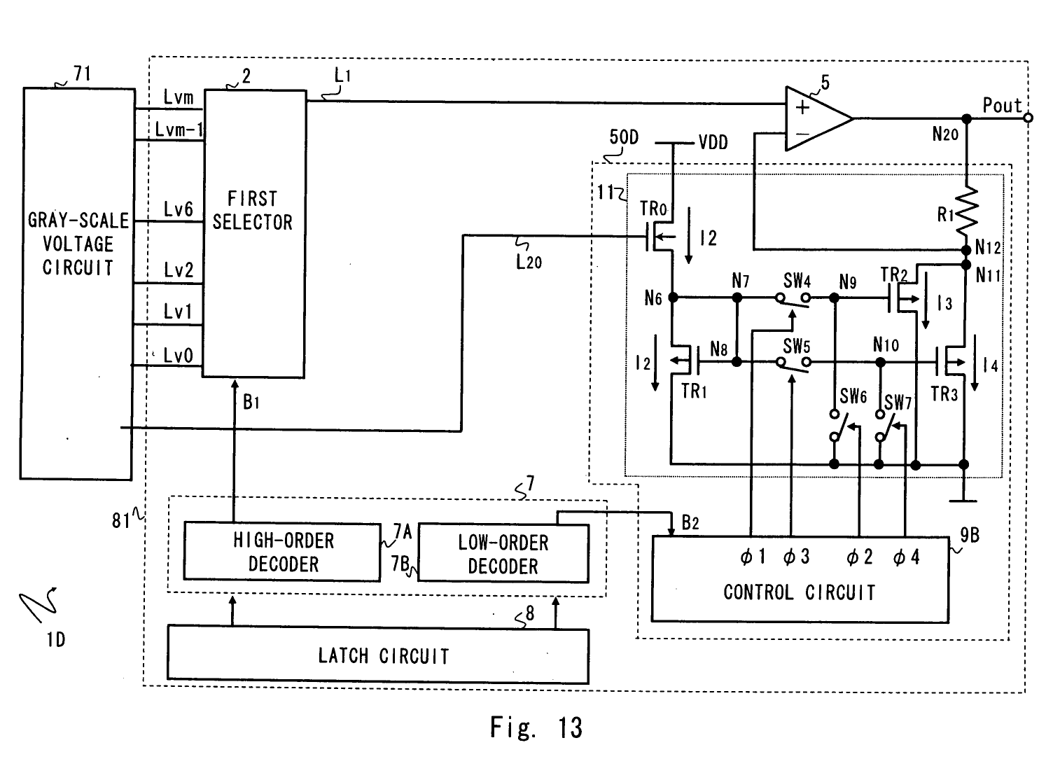

A third exemplary embodiment is described hereinafter with reference to FIGS. 10 to 12. FIG. 10 is an explanatory view to describe a relationship between a gray-scale voltage circuit and a plurality of unit driver circuits. FIG. 11 is a schematic view to describe a configuration of a driver circuit 1C. FIG. 12 is a schematic view to describe a configuration of a gray-scale voltage circuit 70.

In this exemplary embodiment, unlike the first exemplary embodiment, a voltage divider is incorporated into a gray-scale voltage circuit. In such a case also, the same advantage as described in the first exemplary embodiment can be obtained. Further, in this exemplary embodiment, the voltage divider is incorporated into the gray-scale voltage circuit which is common to the plurality of unit driver circuits, rather than into the respective unit driver circuits placed corresponding to the number of data lines of a liquid crystal display device, thereby enabling significant reduction of the circuit area of the driver circuit.

As schematically shown in FIG. 10, the driver circuit 1C includes a plurality of unit driver circuits 80. The plurality of unit driver circuits 80 are placed corresponding to the number of data lines of a liquid crystal display device. Each unit driver circuit 80 is composed of circuits such as an amplifier 5, a selector circuit 90, a decoder circuit 7, a latch circuit 8 and so on. The unit driver circuits 80 have the identical configuration. A detailed configuration of the unit driver circuit 80 is as shown in FIG. 11.

Further, as schematically shown in FIG. 10, the gray-scale voltage circuit 70 is connected to each of the plurality of unit driver circuits 80 through a gray-scale voltage line 71. In other words, the gray-scale voltage circuit 70 supplies a common gray-scale voltage to the plurality of unit driver circuits 80.

FIG. 11 shows a schematic configuration of the driver circuit 1C. As obvious from comparison between FIG. 1 and FIG. 11, the unit driver circuit 80 does not include the voltage divider 3, differently from the first exemplary embodiment. Thus, the second selector 4 is directly connected to the gray-scale voltage circuit 70 through a plurality of lines L₂₀ to L₂₃.

FIG. 12 shows a schematic configuration of the gray-scale voltage circuit 70. Referring to FIG. 12, in this exemplary embodiment, the voltage divider is incorporated into the gray-scale voltage circuit 70. Note that, however, the input terminal of the buffer 40 is connected to a node between a resistor R₃₄ and a resistor R₃₅. Further, the input terminal of the buffer 41 is connected to a node between a resistor R₃₃ and a resistor R₃₄.

In this manner, by incorporating the voltage divider into the gray-scale voltage circuit 70 which is common to the plurality of unit driver circuits 80 rather than incorporating the voltage divider into the unit driver circuits 80, it is possible to significantly reduce the circuit area of the driver circuit 1C. In FIG. 12, the same elements as in the voltage divider 3 shown in FIG. 4 are denoted by the same reference symbols.

### Fourth Exemplary Embodiment

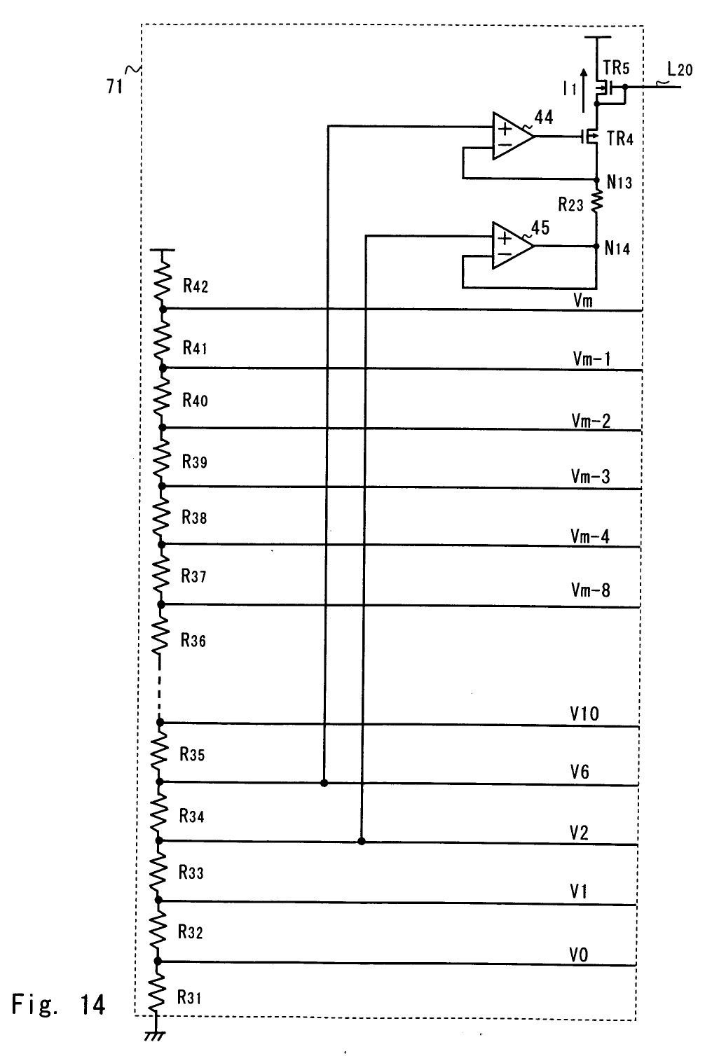

A fourth exemplary embodiment is described hereinafter with reference to FIGS. 13 and 14. FIG. 13 is a schematic view to describe a configuration of a driver circuit 1D. FIG. 14 is a schematic view to describe a configuration of a gray-scale voltage circuit 71.

In this exemplary embodiment, unlike the second exemplary embodiment, a transconductance circuit is incorporated into a gray-scale voltage circuit. In such a case also, the same advantage as described in the second exemplary embodiment can be obtained. Further, in this exemplary embodiment, the transconductance circuit 10 is incorporated into the gray-scale voltage circuit which is common to the plurality of unit driver circuits, rather than into the respective unit driver circuits placed corresponding to the number of data lines of a liquid crystal display device, thereby enabling significant reduction of the circuit area of the driver circuit.

FIG. 13 shows a schematic configuration of the driver circuit 1D. As shown in FIG. 13, a unit driver circuit 81 does not include the transconductance circuit 10 in this exemplary embodiment, differently from the second exemplary embodiment. Thus, the gate of the transistor TR₀ of the potential regulator 11 is directly connected to the gray-scale voltage circuit 71 through a line L₂₀.

FIG. 14 shows a schematic configuration of the gray-scale voltage circuit 71. Referring to FIG. 14, in this exemplary embodiment, the transconductance circuit 10 is incorporated into the gray-scale voltage circuit 71. Note that, however, the non-inverting input terminal of the amplifier 44 is connected to a node between a resistor R₃₄ and a resistor R₃₅. Further, the non-inverting input terminal of the amplifier 45 is connected to a node between a resistor R₃₃ and a resistor R₃₄.

In this manner, by incorporating the transconductance circuit 10 into the gray-scale voltage circuit 71 which is common to the plurality of unit driver circuits 81 rather than incorporating the transconductance circuit 10 into the unit driver circuits 81, it is possible to significantly reduce the circuit area of the driver circuit 1D. In FIG. 14, the same elements as in the transconductance circuit 10 shown in FIG. 8 are denoted by the same reference symbols.

The present invention is not limited to the examples described above. The configurations of the control circuits 9A and 9B are arbitrary. For example, the control circuit 9A may be formed integrally with the second selector 4. The voltage Vout which is output from the driver circuit may have a potential with a negative polarity. The polarity of the regulated voltage may be positive or negative. Those skilled in the art will be able to implement such variations through appropriate design changes.

The first to fourth exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A driver circuit of a display device comprising:
a gray-scale voltage circuit that generates a plurality of reference voltages different from one another;
a first selector circuit that selects any one of the reference voltages as a first selected voltage and selects any one of the reference voltages different from the first selected voltage as a second selected voltage;
an amplifier that outputs an output voltage based on the first selected voltage; and
an output voltage regulator circuit that regulates a potential of the output voltage by using a regulated voltage generated based on the first selected voltage and the second selected voltage.

2. The driver circuit of a display device according to claim 1, wherein the output voltage regulator circuit comprises:
a voltage divider that generates at least one divided voltage based on the first selected voltage and the second selected voltage;
a second selector circuit that selects at least two voltages from a plurality of different voltages output from the voltage divider and outputs the selected voltages; and
a potential regulator that stores a differential voltage between the at least two voltages output from the second selector circuit and regulates a potential of the output voltage by using the differential voltage as the regulated voltage.

3. The driver circuit of a display device according to claim 2, wherein a value of the differential voltage stored in the potential regulator is set according to a potential difference between the at least two voltages selected by the second selector circuit based on at least part of digital data stored in a latch circuit.

4. The driver circuit of a display device according to-Claim 2, wherein the differential voltage stored in the potential regulator is stored by a capacitor with one end electrically connected to an output end of the amplifier.

5. The driver circuit of a display device according to claim 1, wherein the output voltage regulator circuit comprises:
a transconductance circuit that generates a first current based on the first selected voltage and the second selected voltage; and
a potential regulator that regulates a potential of the output voltage by using a voltage obtained based on the first current as the regulated voltage.

6. The driver circuit of a display device according to claim 5, wherein
the potential regulator comprises:
a first current mirror circuit that flows a third current based on the first current; and
a second current mirror circuit that flows a fourth current based on the first current, and
a value of the regulated voltage is set according to whether each of the first current mirror circuit and the second current mirror circuit is controlled into an on-state or an off-state.

7. The driver circuit of a display device according to claim 6, wherein
an input-side transistor of the first current mirror circuit and an input-side transistor of the second current mirror circuit are a common transistor, and
an output-side transistor of the first current mirror circuit and an output-side transistor of the second current mirror circuit are transistors of different sizes.

8. The driver circuit of a display device according to claim 5, wherein the potential regulator comprises a resistor with one end connected to an output end of the amplifier, and regulates a potential of the output voltage by using a voltage generated when a current based on the first current flows into the resistor as the regulated voltage.

9. The driver circuit of a display device according to claim 1, wherein the first selector circuit selects any one of the reference voltages as the first selected voltage and selects any one of the reference voltages different from the first selected voltage as the second selected voltage based on at least part of digital data stored in a latch circuit.

10. A driver circuit of a display device comprising:
a gray-scale voltage circuit that generates a plurality of reference voltages having different voltage values from one another;
a first selector circuit that selects any one of the plurality of reference voltages as a first selected voltage;
an amplifier that outputs an output voltage based on the first selected voltage; and
an output voltage regulator circuit that regulates a potential of the output voltage by using a regulated voltage generated based on a first one and a second one of the reference voltages.

11. The driver circuit of a display device according to claim 10, wherein
the gray-scale voltage circuit comprises a voltage divider that generates at least one divided voltage based on a first one and a second one of the reference voltages, and
the output voltage regulator circuit comprises:
a second selector circuit that selects two voltages from the first one and the second one of the reference voltages, the at least one divided voltage and so on and outputs the selected voltages; and
a potential regulator that stores a differential voltage between the two voltages output from the second selector circuit and regulates a potential of the output voltage by using the differential voltage as the regulated voltage.

12. The driver circuit of a display device according to claim 11, wherein a value of the differential voltage stored in the potential regulator is set according to a potential difference between the two voltages selected by the second selector circuit based on at least part of digital data stored in a latch circuit.

13. The driver circuit of a display device according to claim 11, wherein the differential voltage stored in the potential regulator is stored by a capacitor with one end electrically connected to an output end of the amplifier.

14. The driver circuit of a display device according to claim 10, wherein
the gray-scale voltage circuit comprises a transconductance circuit that generates a first current based on a first one and a second one of the reference voltages, and
the output voltage regulator circuit comprises a potential regulator that regulates a potential of the output voltage by using a voltage generated based on the first current as the regulated voltage.

15. The driver circuit of a display device according to claim 14, wherein
the potential regulator comprises:
a first current mirror circuit that flows a third current based on the first current; and
a second current mirror circuit that flows a fourth current based on the first current, and
a value of the regulated voltage is set according to whether each of the first current mirror circuit and the second current mirror circuit is controlled into an on-state or an off-state.

16. The driver circuit of a display device according to claim 15, wherein
an input-side transistor of the first current mirror circuit and an input-side transistor of the second current mirror circuit are a common transistor, and
an output-side transistor of the first current mirror circuit and an output-side transistor of the second current mirror circuit are transistors of different sizes.

17. The driver circuit of a display device according to claim 14, wherein the potential regulator comprises a resistor with one end connected to an output end of the amplifier, and regulates a potential of the output voltage by using a voltage generated when a current based on the first current flows into the resistor as the regulated voltage.

18. A driver circuit of a display device comprising:
a gray-scale voltage circuit that generates a plurality of reference voltages having different voltage values from one another; and
a plurality of unit driver circuits that are connected to the gray-scale voltage circuit through a plurality of lines, wherein
each of the plurality of unit driver-circuits includes:
a first selector circuit that selects any one of the plurality of reference voltages as a first selected voltage;
an amplifier that outputs an output voltage based on the first selected voltage; and
an output voltage regulator circuit that regulates a potential of the output voltage by using a regulated voltage generated based on a first one and a second one of the reference voltages.
